(19) United States
(12) Patent Application Publication
(10) Pub. No.: US 2003/0165758 A1
(43) Pub. Date: Sep. 4, 2003

(54) Developing agent, method for manufacturing the same, and image forming apparatus

(75) Inventor: Takashi Urabe, Shizuoka-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/084,093

(22) Filed: Feb. 28, 2002

(51) Int. Cl. G03G 9/083

(52) U.S. Cl. 430/106.1; 430/110.2; 430/137.11

(57) ABSTRACT

A multi-layered toner comprises a core containing a first binder resin, and a covering layer containing a second binder resin having an acid value differing from that of the first binder resin. A magnetic powder is contained in at least one of the core and the covering layer.

### BACKGROUND OF THE INVENTION

The present invention relates to a developing agent used in an image forming apparatus of an electrostatic recording system and an electrophotographic system and a method of manufacturing the particular developing agent, particularly, to an image forming apparatus of a magnetic one-component developing system and magnetic one-component developing agent.

In the image formation of an electrophotographic system, an electrostatic latent image is formed on a photoreceptor, followed by developing the electrostatic image with a toner so as to form a toner image. The toner image thus formed is transferred onto a transfer material such as a paper sheet, followed by fixing the toner image to the paper sheet by means of heating and pressurization.

In general, the developing system may be a two-component developing system, in which both a toner and a carrier are used, or a one-component developing system using a toner performing the function of a carrier. Also, one-component developing systems include magnetic and nonmagnetic one-component developing systems. Among these developing systems, the magnetic one-component developing system uses a toner containing 30 to 70 parts by weight of magnetic powder.

In magnetic one-component developing systems, the developing device used is simple in construction, with the result that it is possible to make the developing device compact. Further, the developing agent need not be replaced. However, since the fixing properties are low and the stress given to the photoreceptor is strong, the magnetic one-component developing system gives rise to problems such as film peeling of the photoreceptor and black spot generation.

### BRIEF SUMMARY OF THE INVENTION

An object of the present invention, which has been achieved in view of the situation described above, is to provide a developing agent of low film peeling of the photoreceptor, capable of preventing black spot generation and satisfactory in the fixing properties.

Another object of the present invention is to provide an image forming apparatus low in the film peeling of the photoreceptor, capable of preventing the black spot generation, satisfactory in the fixing properties, and capable of forming a high quality image.

The developing agent of the present invention comprises multi-layered magnetic toner particles each including a toner core containing a first binder resin having a first acid value, a resin covering layer formed on the toner core and containing a second binder resin having a second acid value differing from the first acid value, and a magnetic powder contained in at least one of the toner core and the resin covering layer.

The manufacturing method of the present invention for manufacturing a developing agent comprises the step of obtaining multi-layered magnetic toner particles by covering the surface of a toner core containing a first binder resin having a first acid value with a resin covering material containing a second binder resin having a second acid value differing from the first acid value to form a resin covering layer on the surface of the toner core, wherein a magnetic powder is added to at least one of the toner core and the resin covering layer.

Further, the image forming apparatus of the present invention comprises:

an image carrier;

a developing mechanism including a developing device arranged to face the image carrier and serving to develop an electrostatic latent image formed on the surface of the image carrier so as to form a developing agent image;

a transfer mechanism for transferring the developing agent image onto a transfer material; and

a fixing device for fixing the developing agent image transferred to the transfer material;

wherein housed in the developing device is a developing agent comprising multi-layered magnetic toner particles each including a toner core containing a first binder resin having a first acid value, a resin covering layer formed on the toner core and containing a second binder resin having a second acid value differing from the first acid value, and a magnetic powder contained in at least one of the toner core and the resin covering layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a model drawing for explaining as an example the construction of the toner used in the developing agent of the present invention;

FIG. 2 is a conceptual view for explaining the principle of a mechanofusion treatment;

FIG. 3 schematically shows as an example the construction of an apparatus used for a hybridization treatment;

FIG. 4 is a schematic view for explaining a surfusing system;

FIG. 5 is a flow chart showing as an example the method of the present invention for manufacturing a toner;

FIG. 6 is a flow chart showing as another example the method of the present invention for manufacturing a toner;

FIG. 7 shows as an example the construction of an image forming apparatus used preferably in the present invention; and

FIG. 8 is a drawing for explaining the developing device shown in FIG. 7.

### DETAILED DESCRIPTION OF THE INVENTION

The developing agent of the present invention comprises multi-layered toner particles each containing a toner core and a resin covering layer formed on the surface of the toner core. The toner core contains a first binder resin having a first acid value. The resin covering layer contains a second binder resin having a second acid value differing from said first acid value. Further, a magnetic powder is contained in at least one of the toner core and the resin covering layer.

The magnetic toner particle used in the present invention has a multi-layered structure including a toner core containing a binder resin and a resin covering layer containing another binder resin. The acid value of the binder resin contained in the toner core differs from that of the binder resin contained in the resin covering layer. Therefore, it is possible to separate the function of the toner core from the function of the resin covering layer by controlling the acid value of the binder resin.

For example, it is possible to make the first acid value higher than the second acid value for separating the function as pointed out above. As a result, a binder resin having a high acid value is applied to the toner core for obtaining satisfactory fixing properties, and a binder resin having a low acid value is applied to the resin covering layer for obtaining a satisfactory storage properties under high temperatures and a high resistance to stress. By this separation of the function, it is possible to satisfy simultaneously the fixing properties, the charging characteristics, the resistance to stress and the storage properties under high temperatures, though it was difficult for the magnetic toner of a single layer structure to satisfy these properties simultaneously.

It is preferable for the first acid value to be higher than the second acid value and for the first acid value to be at least 10, more preferably, to be 10 to 80. On the other hand, it is preferable for the second acid value to be 0 to 5. If the first acid value is lower than 10, the fixing properties tend to be lowered. Also, if the second acid value exceeds 5, the dependence of the charging properties on the environment tends to be increased.

It is preferable for the difference in the acid value between the first binder resin and the second binder resin to be 5 to 80. Incidentally, it suffices for the first and second binder resins used in the present invention to differ from each other in the acid value. Therefore, it is possible for the binder resin to have an acid value of 0.

It is possible to add a magnetic powder to at least one of the toner core and the resin covering layer. It is desirable for the content of the magnetic powder to fall within a range of between 30 and 70% by weight based on the total weight of the toner particles.

It is preferable for the magnetic powder to be added to the toner core. If the magnetic powder is added to the toner core, it is possible to prevent the magnetic powder from being exposed to the surface of the developing agent so as to be brought into direct contact with the surface of the photoreceptor, with the result that the film peeling of the photoreceptor and the black spot generation can be prevented effectively.

Further, it is possible to have the magnetic powder covered in advance with resin. Where the magnetic powder is covered with resin, the magnetic powder is of course contained in the toner core. In addition, even where the magnetic powder is contained in the resin covering layer, it is possible to prevent the magnetic powder from being exposed to the surface of the developing agent so as to be brought into direct contact with the surface of the photoreceptor, with the result that the film peeling of the photoreceptor and the black spot generation can be prevented effectively.

Where the magnetic powder is contained in the toner core, it is preferable for the resin used for covering the magnetic powder to be a resin having an acid value substantially equal to that of the first binder resin. In this case, it is possible to prevent the magnetic powder from being exposed to the surface of the developing agent so as to be brought into direct contact with the surface of the photoreceptor, with the result that the film peeling of the photoreceptor and the black spot generation can be prevented effectively, without impairing the characteristics, e.g., the fixing properties, of the first binder resin. It is more preferable for the resin used for covering the magnetic powder to be the first binder resin.

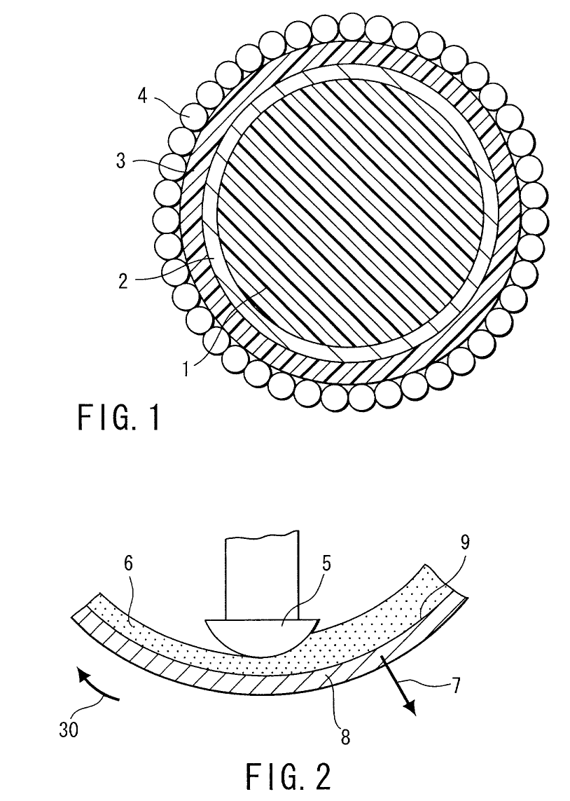

FIG. 1 is a model drawing for explaining as an example the construction of the toner used in the developing agent of the present invention.

As shown in the drawing, the toner of the present invention comprises multi-layered magnetic toner particles each including a toner core body 1 containing mainly a first binder resin having a first acid value, a magnetic powder layer 2 formed on the toner core body 1 and consisting of a magnetic powder covered in advance with the first binder resin, and a resin covering layer 3 formed on the surface of the magnetic powder layer 2 and containing mainly a second binder resin having a second acid value differing from the first acid value, and additive particles 4 attached optionally to the surface of the multi-layered magnetic toner particle, i.e., on the surface of the resin covering layer 3.

As described above, it is desirable for the toner core to contain a magnetic powder and the first binder resin.

As shown in FIG. 1, it is possible to attach a coloring agent to the surface of the core body containing mainly the first binder resin. Alternatively, it is possible to disperse the magnetic powder within the toner core.

It is possible to add appropriately other additives such as a wax and a charge control agent to the toner core.

The other additives used in the present invention include, for example, a lubricant, a cleaning assistant and a fluidizing agent.

Also, the additive particles used in the present invention include, for example, silica, titania, alumina particles, a metal soap and resin fine particles.

It is possible to form the toner core by, for example, a polymerization method or a pulverization method.

As described previously, the resin covering layer contains at least the second binder resin.

It is possible to add, for example, a magnetic powder covered in advance with resin, a wax, a lubricant, a cleaning assistant, and a fluidizing agent to the resin covering layer, as required.

The addition of a wax to the toner core alone is more desirable than the addition to the resin covering layer. Where a wax is added to the toner core alone, it is possible to further improve the resistance to the stress.

It is possible for the second binder resin contained in the resin covering layer to be different from or equal to the first binder resin contained in the toner core in the main constituting portion of the repeating unit of the polymer, although it is desirable to select resins compatible with each other in order to obtain a sufficient strength required for the toner.

The resin covering layer is formed by either a polymerization process or a dry process.

In the case of employing the polymerization process, the resin covering layer can be formed by carrying out a polymerizing reaction, with the raw material of the second binder resin, e.g., an optional material selected from the monomer, oligomer, low molecular weight polymer and auxiliary polymer, applied to the toner core.

The dry process employed in the present invention represents a process for covering the surface of the toner core with a material containing a resin as a main component. The dry process includes the process other than the polymerization processes performed within a liquid such as a solution polymerization process, a suspension polymerization process and an emulsion polymerization process. Since the properties of the resins are changed depending on the manufacturing process even if the same kind of resin materials are used for forming the covering layer, the covering layer formed by the dry process can be clearly distinguished from the covering layer formed by the polymerization process.

The dry process employed in the present invention includes, for example, a mechanical process, a thermal process, a mechanochemical process and a process involving at least two of these processes.

It should also be noted that, according to the present invention, it is possible to form the resin covering layer by the dry process such as a mechanical process, a thermal process or a mechanochemical process in place of the costly polymerization process carried out within a liquid such as a solution polymerization method, a suspension polymerization method or an emulsion polymerization process, with the result that it is possible to manufacture the toner having a multi-layered structure easily and at a low manufacturing cost. Further, the additive such as a charge control agent can be applied easily to the resin covering layer.

The resin covering layer can be formed by performing the dry process only once by using a single resin covering material. It is also possible to form the resin covering layer by a plurality of dry processes by using a single resin covering material and changing, for example, the kinds and the conditions of the dry processes. Further, it is possible to form the resin covering layer such that the toner core is covered with an optional resin covering material by a plurality of dry processes using a plurality of resin covering materials. It should also be noted that the additives that can be applied to the surface of the toner particle such as a cleaning assistant and a fluidizing agent can be attached easily to the resin covering layer after the dry process.

Incidentally, powdery resin materials such as particles of a single resin, resin composition particles and particles having a toner composition can be suitably used as the resin covering material in the dry process.

The dry process that can be employed in the present invention includes, for example, a mechanofusion process, a hybridization process and a surfusing process.

FIG. 2 conceptually shows the principle of the mechanofusion process. The mechanofusion process is one of the mechanochemical processes. In the mechanofusion process, an ordered mixture, which is prepared by subjecting a powdery material containing, for example, mother particles and child particles to a dry mixing so as to permit the child particles to be attached to the mother particles, is put as a powdery raw material 6 in a rotary container 8 rotating in a direction denoted by, for example, an arrow 30. Within the rotary container 8, the powdery raw material 6 is pushed against and fixed to the inner wall 9 of the rotary container 8 by the centrifugal force acting in the direction denoted by an arrow 7. In addition, an inner piece 5 differing from the inner wall 9 in the radius of curvature is applied to the fixed powdery material 6 so as to impart a stronger compression and shearing force to the fixed powdery raw material 6, thereby preparing composite particles, controlling the shape of the particles and achieving a precision mixing.

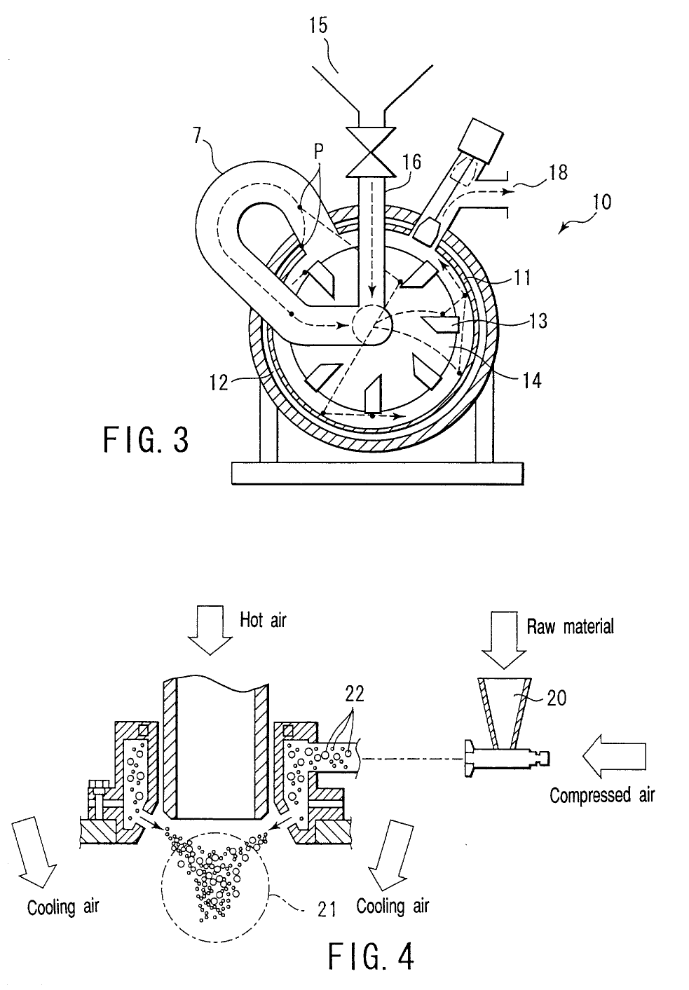

FIG. 3 schematically shows as an example an apparatus used in the hybridization process.

The hybridization process is one the mechanical and thermal processes. Used in the hybridization process is, for example, an apparatus 10 shown in the drawing. The apparatus 10 comprises a cylindrical stator 11 provided with a jacket 12 for the water cooling and for heating, a rotor 14 provided with a plurality of blades 13 and capable of a high speed rotation, an input port 15 for introducing a powdery material into the stator 11, a transfer path 16 for transferring the powdery raw material to the central portion of the rotor 14, a circulating path 17 for transferring again the powdery material from the inner wall of the stator 11 to the central portion of the rotor 14, and a discharge port 18 for discharging the processed powdery material.

As shown in the drawing, a powdery raw material, e.g., an ordered mixture, is put into the apparatus 10 through the inlet port 15 so as to be dispersed onto the inner surfaces of the rotor 14 rotating at a high speed and the stator 11. Further, the powdery raw material is circulated again from the inner surface of the stator 11 into the central portion of the rotor 14 through the circulating path 17. In this case, mechanical functions such as the impact force including the mutual function among the particles, compression, friction and shearing force are repeatedly applied to the powdery raw material so as to permit the child particles to fix the mother particles, to form a film, and to make the particles spherical. The processed powdery material is discharged to the outside through the discharge port 18 so as to be recovered promptly in a collector (not shown). Incidentally, the letter P shown in the drawing denotes the powdery material, and the arrow of the broken line denotes the behavior of the powdery material P.

FIG. 4 schematically shows a surfusing system. The surfusing system is one of the thermal processes. In the surfusing system, a powdery raw material 22, e.g., an ordered mixture, put through an inlet port 20 is dispersed into a hot air stream within a process section 21 by a special method using a compressed air, as shown in the drawing, so as to heat the powdery raw material 22 to temperatures not lower than the temperature at which the powdery raw material 22 begins to be melted. As a result, the powdery material is made spherical and the child particles are fixed to the mother particles. Where resin fine particles constitute the child particles, it is possible to permit the child particles to be attached to the mother particles so as to form a film.

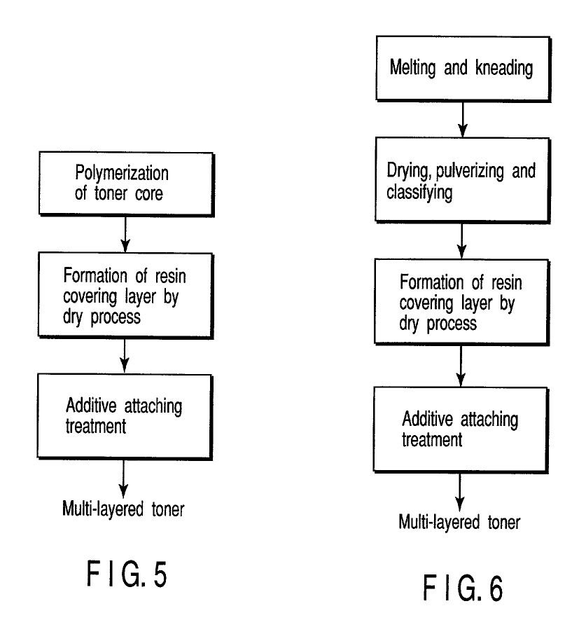

FIGS. 5 and 6 are flow charts each showing the process of manufacturing a multi-layered toner, covering the case where the resin covering layer is formed by a dry process.

As shown in FIG. 5, the toner manufacturing method covering the case where the toner core is formed by the polymerization process comprises the step of polymerizing the toner core polymerizing material containing a magnetic powder as well as a monomer and a prepolymer of the binder resin so as to obtain the toner core, the step of forming a resin covering layer on the surface of the toner core thus obtained by a dry process so as to obtain multi-layered magnetic toner particles, and the step of attaching an additive to the multi-layered magnetic toner particles.

A modification of the manufacturing method described above comprises the step of polymerizing a polymerizing material of the toner core that does not contain a magnetic powder so as to obtain a toner core body, the step of attaching a magnetic powder to the surface of the toner core body so as to form a toner core, the step of forming a resin covering layer by a polymerization process or a dry process on the surface of the toner core so as to obtain a multi-layered magnetic toner particle, and the step of attaching an optional additive to the multi-layered magnetic toner particles.

The toner core prepared by the polymerization method is relatively small in the nonuniformity of the in particle diameter. Therefore, it is possible to obtain toner particles of uniform diameter and shape.

Also, where the toner core is formed by the pulverizing method, the method of manufacturing a developing agent comprises the step of melting and kneading a toner core material containing, for example, a magnetic powder and a binder resin, the step of drying and pulverizing the kneaded material thus obtained, followed by classifying the pulverized material so as form a toner core, the step of forming a resin covering layer by a dry process on the obtained toner core so as to obtain multi-layered magnetic toner particles, and attaching an optional additive to the multi-layered magnetic toner particles thus obtained, as shown in FIG. 6.

A modification of the manufacturing method shown in FIG. 6 comprises the step of melting and kneading a toner core material that does not contain a magnetic powder, the step of drying and pulverizing the kneaded mass, followed by classifying the pulverized material so as to form a toner core body, the step of attaching a magnetic powder to the surface of the toner core body so as to form a toner core, the step of forming a resin covering layer by a dry process on the surface of the toner core thus formed so as to obtain a multi-layered magnetic toner particle, and the step of attaching an optional additive to the surface of the multi-layered magnetic toner particle.

The toner core prepared by the pulverizing process is somewhat nonuniform in the particle diameter and has a random shape. However, an impact is imparted to the toner core by the dry process in the step of forming the resin covering layer, with the result that the resultant multi-layered toner particle is rendered spherical. Also, the toner particles shaped somewhat irregular are advantageous over the spherical toner particles having a uniform particle diameter in that the toner particles are unlikely to pass through, for example, a cleaning blade in an image forming apparatus equipped with a cleaning apparatus using the cleaning blade, with the result that it is possible to expect an improvement in the cleaning function.

Incidentally, the additive attaching step is optional and, thus, can be omitted. Also, in the manufacturing method described above, the resin covering layer is formed by the dry process. However, it is also possible to employ a polymerization process in place of the dry process. It should be noted, however, that, where a resin covering layer is formed on the toner core, the dry process is advantageous over the polymerization process in the manufacturing cost of the developing agent.

The image forming apparatus to which the developing agent of the present invention can be applied comprises:

at least one image carrier;

a developing mechanism arranged to face the image carrier and including a developing device for developing an electrostatic latent image formed on the image carrier so as to form a developing agent image;

a transfer mechanism for transferring the developing agent image formed on the image carrier onto a transfer material; and

a fixing device for fixing the developing agent image transferred onto the transfer material;

wherein housed in said developing device is a developing agent comprising multi-layered magnetic toner particles each including a toner core containing a first binder resin having a first acid value, a resin covering layer formed on said toner core and containing a second binder resin having a second acid value differing from said first acid value, and a magnetic powder contained in at least one of said toner core and said resin covering layer.

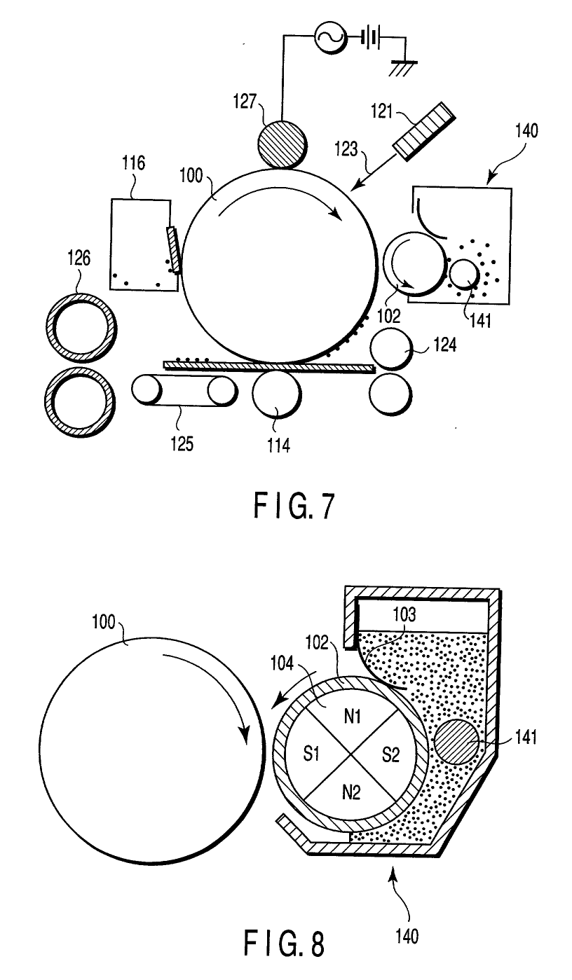

FIG. 7 shows as an example the preferred construction of an image forming apparatus that is used in the present invention.

As shown in FIG. 7, the image forming apparatus comprises a photoreceptor drum 100. Arranged around the photoreceptor drum 100 are a primary charging roller 127, a developing device 140, a transfer charging roller 114, a cleaner 116, a resist roller 124, etc. The photoreceptor drum 100 is charged to, for example, −700V by the primary charging roller 127. The applied voltage in this step is, for example, an AC voltage of −2.0 kVpp or a DC −700 Vdc. The photoreceptor drum 100 is irradiated with laser light 123 emitted from a laser generating device 121. The electrostatic latent image formed on the surface of the photoreceptor drum 100 is developed with a magnetic one-component toner by the developing device 140 and, then, the resultant toner image is transferred onto the transfer material by the transfer roller 114 abutting against the photoreceptor drum 100 with the transfer material interposed therebetween. The transfer material bearing the toner image is transferred to the fixing device 126 by, for example, the transfer belt 125 so as to be fixed to the transfer material. Also, the toner partly remaining on the photoreceptor drum 100 is removed by the cleaning means 116. It is unnecessary to use the cleaning means 116 in the case where the developing step includes the cleaning step for recovering the toner remaining on the surface of the image carrier after transfer of the toner image onto the recording medium as described above.

FIG. 8 schematically shows the construction of the magnetic one-component developing device 140. As shown in the drawing, the developing device 140 includes a cylindrical toner carrier 102, hereinafter referred to as “developing sleeve”, arranged adjacent to the photoreceptor drum 100 and made of a nonmagnetic metal such as aluminum or stainless steel. The clearance between the photoreceptor drum 100 and the developing sleeve is held at about 300 μm by a clearance securing member arranged between the sleeve and the photoreceptor drum. A magnet roller 104 is arranged concentric to the developing sleeve 102 and fixed within the developing sleeve. It should be noted, however, that the developing sleeve 102 is rotatable. As shown in the drawing, the magnet roller 104 is provided with a plurality of magnetic poles S1, N1, S2 and N2. The magnetic pole S1 affects the development. The magnetic pole N1 affects the toner coating amount control. The magnetic pole S2 affects the in-take and transfer of the toner. Further, the magnetic pole N2 affects the function of preventing the blow out of the toner. An elastic blade 103 is arranged as a member for regulating the amount of the magnetic toner attached to and transferred by the developing sleeve 102 so as to control the amount of the toner transferred to the developing region by the contact pressure of the elastic blade 103 against the developing sleeve 102. In the developing region, a DC or AC developing bias is applied between the photoreceptor drum 100 and the developing sleeve 102 so as to permit the toner on the developing sleeve to jump onto the photoreceptor drum 100 in accordance with the electrostatic latent image formed on the surface of the photoreceptor drum 100, thereby forming a visible image.

The apparatus of the construction described above is no more than an example of the image forming apparatus to which the developing agent of the present invention can be applied. In words, it is possible to apply the developing agent of the present invention to an image forming apparatus of another construction. Also, the charging means of the photoreceptor is not limited to a contact charging means.

The binder resin used in the present invention includes, for example, a polyester resin, a polystyrene resin, a styrene-acrylate copolymer resin, a polyester-styrene acrylate hybrid resin, an epoxy resin, and a polyether-polyol resin.

The wax used in the present invention includes, for example, natural waxes such as rice wax and carnauba wax; petroleum waxes such as paraffin wax; and synthetic waxes such as a fatty acid ester, a fatty acid amide, a low molecular weight polyethylene, and a low molecular weight polypropylene.

The magnetic powder used in the present invention includes, for example, magnetite, ferrite, iron, cobalt, nickel and γ-iron oxide.

Further, it is possible to use carbon black as a coloring agent, as required. The carbon black used in the present invention includes, for example, acetylene black, furnace black, thermal black, channel black, and ketchen black.

### EXAMPLES

The present invention will now be described in more in detail with reference to the Examples.

### Example 1

Resin Covering Film Containing Magnetic Powder:

Prepared was a resin covering material of the composition given below, which contained a magnetic powder.

Magnetic Powder Resin Covering Material 1:

| | |
|---|---|
| Polyester resin (acid value of 10) | 20 parts by weight |
| Magnetite | 80 parts by weight |

A mixture of the materials given above was subjected to a surface treatment by using the hybridization system manufactured by Nara Kikai K.K. so as to have the surface of the magnetite particle covered with the polyester resin, thereby obtaining a desired magnetic powder 1 covered with a resin.

Manufacture of Toner Core:

Prepared were the toner core materials given below:

| | |
|---|---|
| Polyester resin (acid value of 10) | 60 parts by weight |
| Magnetic powder 1 | 35 parts by weight |
| Propylene wax | 4 parts by weight |
| Colored metal complex CCA | 1 part by weight |

A mixture consisting of the obtained magnetic powder 1 and the toner core material given below was kneaded by using a biaxial extruder so as to obtain a sheet of the kneaded material. Then, the sheet thus obtained was roughly pulverized by a mechanical pulverizing machined into particles each having a diameter of about 1 mm, followed by further pulverizing the roughly pulverized particles by an ultrasonic jet pulverizing machine into fine particles having an average particle diameter of 8 μm and subsequently classifying the fine particles by using an air current classifying machine so as to obtain toner core 1.

Manufacture of Multi-Layered Toner Particles:

Further, prepared were the materials of the multi-layered toner particles given below.

Materials of multi-layered toner particles:

| | |
|---|---|
| Toner core 1 | 80 parts by weight |
| Second binder resin (polyester resin particles | 20 parts by weight |
| having acid value of 5 and average particle diameter | |
| of 1 μm) | |

The materials of the multi-layered toner particles given above were applied to a surfusing system manufactured by NPK K.K. so as to cover the surface of the toner core with the polyester resin, thereby obtaining multi-layered magnetic toner particles 1.

Further, 100 parts by weight of the multi-layered magnetic toner particles and 0.4 part by weight of silica were mixed by using a Henschel mixer manufactured by Mitsui Kozan K.K. so as to apply a surface treatment to the multi-layered magnetic toner particles with the silica particles, thereby obtaining a toner 1.

The toner 1 thus obtained was set in a printing machine “Premage 255” manufactured by Toshiba Tec K.K., which was modified for use for the test, and the fixing temperature was set at 180° C. Under this condition, a test printing for an image was performed.

Test for Fixation Remaining Rate:

A ratio of the image density before rubbing of the image with a fastness tester and the image density after the rubbing were measured. The image having a fixation remaining rate not lower than 80% was evaluated as a good image having a sufficient image strength. The image having a fixation remaining rate of 70 to 79% was evaluated as an image that does not give rise to a practical problem. Further, the image having a fixation remaining rate not higher than 69% was evaluated as a poor image low in the image strength.

The fixation remaining rate was found to be 82%, supporting that it was possible to obtain a satisfactory image having a sufficient fixing strength.

Test for Change in Charging Properties with Environment:

Two kinds of developing agents were prepared by using the obtained toner. The developing agents thus prepared were put in an environment of a low temperature and a low humidity having a temperature 10° C. and a humidity of 20% and left to stand for at least 8 hours, and also put in an environment of a high temperature and a high humidity having a temperature 30° C. and a humidity of 85% and left to stand for at least 8 hours, to age them.

Then, each of the developing agents was applied to Premage 255 referred to above so as to measure the charging amount after the aging treatment by using the “q/m-meter apparatus” manufactured by TREK Inc. The average charging amount (L/L) q/m of the developing agent, which had been left to stand under the low temperature-low humidity environment was found to be 1.2 (−μC/g), and the average charging amount (H/H)q/m of the developing agent, which had been left to stand under the high temperature-high humidity environment was found to be 9.25 (−μC/g).

The value of (L/L)/(H/H) was calculated so as to obtain a rate of change with the environment. The rate of change with the environment was found to be 1.33, supporting that it is possible to obtain a satisfactory image low in the fogging regardless of the environmental atmosphere. If the rate of change with the environment is not higher than 1.4, it is possible to obtain a satisfactory image low in fogging regardless of the environmental atmosphere. Also, if the rate of change with the environment is higher than 1.4 and is not higher than 1.6, it is possible to obtain a satisfactory image low in fogging regardless of the environmental atmosphere. Also, if the rate of change with the environment is higher than 1.6, obtained is a defective image that is high in fogging in spite of the control applied to the machine.

The scraping amount of the photosensitive layer, which was measured after the printing on 30,000 paper sheets, was found to be 2.4 μm. This clearly supports that the stress applied to the photoreceptor drum is sufficiently low. Incidentally, in order to obtain a satisfactory image, it is necessary for the scraping amount of the drum film to be not larger than 3.0 μm.

### Example 2

A developing agent was prepared as in Example 1, except that the magnetic powder was not covered with a resin film, and tests similar to those in Example 1 were conducted. Table 1 shows the result.

### Examples 3 and 4

A developing agent was prepared as in Example 1, except that the acid value of the covering resin of the magnetic powder was changed as shown in Table 1, and tests similar to those in Example 1 were conducted. Table 1 shows the result.

### Examples 5 and 6

A developing agent was prepared as in Example 1, except that the acid value of the first binder resin or the second binder resin was changed as shown in Table 1, and tests similar to those in Example 1 were conducted. Table 1 shows the result.

### Comparative Examples 1 and 2

A developing agent was prepared as in Example 1, except that the acid value of the first binder resin or the second binder resin was changed such that these first and second binder resins had the same acid value as shown in Table 1, and tests similar to those in Example 1 were conducted. Table 1 shows the result.

TABLE 1

| | Covering | Acid value of | | | Scraping | | |
|---|---|---|---|---|---|---|---|
| | of | resin covering | First | Second | amount | Fixation | Rate of |
| | magnetic | magnetic | acid | acid | of film | remaining | change with |
| | powder | powder | value | value | (μm) | rate (%) | environment |
| Example 1 | covered | 10 | 10 | 5 | 2.4 | 82 | 1.33 |
| Example 2 | none | — | 10 | 5 | 3.9 | 72 | 1.24 |
| Example 3 | covered | 9 | 10 | 5 | 2.5 | 77 | 1.30 |
| Example 4 | covered | 5 | 10 | 5 | 2.6 | 67 | 1.22 |
| Example 5 | covered | 10 | 9 | 5 | 2.7 | 78 | 1.29 |
| Comparative | covered | 10 | 5 | 5 | 2.6 | 58 | 1.22 |
| Example 1 | | | | | | | |
| Example 6 | covered | 10 | 10 | 6 | 2.4 | 82 | 1.45 |
| Comparative | covered | 10 | 10 | 10 | 2.3 | 85 | 1.67 |
| Example 2 | | | | | | | |

It can be understood by the comparison between Example 1 and Example 2, that, if the magnetic powder is covered with resin, the stress given to the photoreceptor drum can be lowered so as to decrease the scraping amount of the photosensitive amount. It can also be understood by the comparison among Example 1, Example 2 and Example 4, that satisfactory fixing properties can be obtained if the resin covering the magnetic particle has an acid value not smaller than 10.

It can also be understood by the comparison between Example 1 and Example 2 that it is desirable for the matrix resin to have an acid value not smaller than 10.

Further, it can also be understood by the comparison among Example 1, Comparative Example 1 and Example 6, that it is desirable for the resin covering the surface of the multi-layered magnetic toner to have an acid value not larger than 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent including a multi-layered magnetic toner particle, said multilayered magnetic toner particle comprising:
a toner core containing a first binder resin having a first acid value,
a resin covering layer formed on said toner core and containing a second binder resin having a second acid value differing from said first acid value, and
a magnetic powder contained in at least one of said toner core and said resin covering layer.

2. The developing agent according to claim 1, wherein said first acid value is not lower than 10.

3. The developing agent according to claim 2, wherein said first acid value falls within a range of between 10 and 80.

4. The developing agent according to claim 1, wherein said second acid value falls within a range of between 0 and 5.

5. The developing agent according to claim 1, wherein said first acid value is not smaller than 10, and said second acid value falls within a range of between 0 and 5.

6. The developing agent according to claim 1, wherein the difference between said first acid value and said second acid value falls within a range of between 5 and 80.

7. The developing agent according to claim 1, wherein said toner core further contains a wax.

8. The developing agent according to claim 1, wherein said toner core is formed by one process selected from the group consisting of a polymerization process and a pulverizing process.

9. The developing agent according to claim 1, wherein said resin covering layer is formed by one process selected from the group consisting of a polymerization process and a dry process.

10. The developing agent according to claim 8, wherein said dry process is selected from the group consisting of a mechanical process, a thermal process, a mechanochemical process and a complex process involving at least two of these dry processes.

11. The developing agent according to claim 8, wherein said dry process is selected from the consisting of a mechanofusion process, a hybridization process and a surfusing process.

12. The developing agent according to claim 1, wherein said magnetic powder is covered in advance with resin.

13. The developing agent according to claim 11, wherein said resin is equal to said first binder resin.

14. The developing agent according to claim 1, wherein said magnetic powder is attached to the surface of a core body containing mainly a binder resin.

15. The developing agent according to claim 1, wherein said magnetic powder is dispersed in said toner core.

16. The developing agent according to claim 1, wherein said resin covering layer further contains a magnetic powder covered in advance with resin.

17. The developing agent according to claim 1, wherein said magnetic powder is contained in an amount of 30 to 70% by weight based on the total weight of the toner particles.

18. A method of manufacturing a developing agent, comprising:
forming a resin covering layer on the surface of a toner core containing a first binder resin having a first acid value, said resin covering layer containing a second binder resin having a second acid value differing from said first acid value to obtain multi-layered magnetic toner particles; and
adding a magnetic powder in at least one of the first binder resin and the second binder resin.

19. The method of manufacturing a developing agent according to claim 18, wherein said toner core is formed by one process selected from the group consisting of a polymerization process and a pulverizing process.

20. The method of manufacturing a developing agent according to claim 18, wherein said resin covering layer is formed by one process selected from the group consisting of a polymerization process and a dry process.

21. The method of manufacturing a developing agent according to claim 20, wherein said dry process is selected from the group consisting of a mechanical process, a thermal process, a mechanochemical process and a complex process involving at least two of these dry processes.

22. The method of manufacturing a developing agent according to claim 20, wherein said dry process is selected from the consisting of a mechanofusion process, a hybridization process and a surfusing process.

23. The method of manufacturing a developing agent according to claim 18, wherein said magnetic powder is covered in advance with resin.

24. The method of manufacturing a developing agent according to claim 23, wherein said resin is equal to said first binder resin.

25. An image forming apparatus, comprising:
an image carrier;
a developing mechanism including a developing device arranged to face said image carrier and serving to develop an electrostatic latent image formed on the surface of said image carrier to form a developing agent image;
a transfer mechanism for transferring said developing agent image onto a transfer material; and
a fixing device for fixing the developing agent image transferred to said transfer material;
wherein said developing agent is housed in said developing device, includes multi-layered magnetic toner particles, said multi-layered toner particles comprising a toner core containing a first binder resin having a first acid value, a resin covering layer formed on said toner core and containing a second binder resin having a second acid value differing from said first acid value, and a magnetic powder contained in at least one of said toner core and said resin covering layer.
